(19) United States
(12) Patent Application Publication
(10) Pub. No.: US 2015/0062779 A1
(43) Pub. Date: Mar. 5, 2015

(54) EDLC ELECTRODE AND MANUFACTURING PROCESS THEREOF

(71) Applicant: Corning Incorporated, Corning, NY (US)

(72) Inventors: Jonas Bankaitis, Horseheads, NY (US); Atul Kumar, Horseheads, NY (US); Martin Joseph Murtagh, Trumansburg, NY (US); Obiefuna Chukwuemeka Okafor, Painted Post, NY (US); Kamjula Pattabhirami Reddy, Corning, NY (US)

(73) Assignee: Corning Incorporated, Corning, NY (US)

(21) Appl. No.: 14/164,796

(22) Filed: Jan. 27, 2014

Related U.S. Application Data
(60) Provisional application No. 61/872,210, filed on Aug. 30, 2013.

(51) Int. Cl. H01G 11/86; H01G 11/32

(52) U.S. Cl. CPC H01G 11/86; H01G 11/32
USPC 361/502; 264/105; 156/62.4

(57) ABSTRACT

A method of forming a carbon-based electrode includes forming a mixture of activated carbon particles, carbon black particles, binder, and an optional liquid, fibrillating the binder to form a fibrillated mixture, and forming a carbon mat from the fibrillated mixture, wherein the mixture, during the forming of the mixture, is maintained at a temperature less than 19° C. The low temperature process facilitates dispersive and distributive mixing of the components of the carbon mat.

### CROSS-REFERENCE TO RELATED APPLICATIONS

This application claims the benefit of priority under 35 U.S.C. §119 of U.S. Application Ser. No. 61/872,210 filed on Aug. 30, 2013, the entire content of which is hereby incorporated by reference.

### BACKGROUND

1. Field

The present disclosure relates generally to carbon-based electrodes for energy storage devices, and more specifically to a method for forming carbon-based electrodes that include activated carbon, carbon black and a binder.

2. Technical Background

Energy storage devices such as ultracapacitors may be used in a variety of applications such as where a discrete power pulse is required. Example applications range from cell phones to hybrid vehicles. Ultracapacitors, also referred to as electric double layer capacitors (EDLCs), have emerged as an alternative or compliment to batteries in applications that require high power, long shelf life, and/or long cycle life. Ultracapacitors typically comprise a porous separator and an organic electrolyte sandwiched between a pair of carbon-based electrodes. The energy storage is achieved by separating and storing electrical charge in the electric double layers that are created at the interfaces between the electrodes and the electrolyte. Important characteristics of these devices are the energy density and power density that they can provide, which are both largely determined by the properties of the carbon that is incorporated into the electrodes.

The performance of an EDLC can be correlated to the performance of the carbon-based electrodes. Accordingly, it would be advantageous to provide a method of making robust carbon-based electrodes having desirable electric and dielectric properties, in addition to suitable mechanical strength.

### BRIEF SUMMARY

In accordance with embodiments of the present disclosure, a method of forming a carbon-based electrode comprises forming a mixture including activated carbon particles, carbon black particles, binder, and an optional liquid, and forming a carbon mat from the mixture, wherein forming the mixture comprises mixing the activated carbon particles, carbon black particles, binder and optional liquid at a temperature less than 19° C. In embodiments, during the act of forming the mixture the activated carbon temperature, the carbon black temperature, the binder temperature, and the optional liquid temperature are each less than 19° C. In further embodiments, an EDLC comprises a carbon-based electrode made according to the disclosed method whereby the EDLC has a normalized capacitance of at least 80% of an initial capacitance at 1200 hr of operation.

Additional features and advantages of the subject matter of the present disclosure will be set forth in the detailed description which follows, and in part will be readily apparent to those skilled in the art from that description or recognized by practicing the subject matter of the present disclosure as described herein, including the detailed description which follows, the claims, as well as the appended drawings.

It is to be understood that both the foregoing general description and the following detailed description present embodiments of the subject matter of the present disclosure, and are intended to provide an overview or framework for understanding the nature and character of the subject matter of the present disclosure as it is claimed. The accompanying drawings are included to provide a further understanding of the subject matter of the present disclosure, and are incorporated into and constitute a part of this specification. The drawings illustrate various embodiments of the subject matter of the present disclosure and together with the description serve to explain the principles and operations of the subject matter of the present disclosure. Additionally, the drawings and descriptions are meant to be merely illustrative, and are not intended to limit the scope of the claims in any manner.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1 is a high-resolution SEM micrograph of individual PTFE particles;

FIG. 2 is a high-resolution SEM micrograph of agglomerated PTFE particles;

FIG. 3 is a graph of the relative density of PTFE versus temperature;

FIG. 4 is a plot of specific flow energy versus flow rate for various mixing conditions;

FIG. 5 is an SEM image of a carbon mat according to one embodiment;

FIG. 6 is an SEM image of a carbon mat according to a further embodiment;

FIG. 7 is a schematic illustration of an example ultracapacitor;

FIG. 8 shows optical micrographs of carbon-based electrodes according to a comparative method and a corresponding energy-dispersive x-ray scan showing high concentrations of fluorine;

FIG. 9 is an optical micrograph of a carbon-based electrode according to various embodiments; and

FIG. 10 is a normalized plot of capacitance versus time for example test cells.

### DETAILED DESCRIPTION

Reference will now be made in greater detail to various embodiments of the subject matter of the present disclosure, some embodiments of which are illustrated in the accompanying drawings. The same reference numerals will be used throughout the drawings to refer to the same or similar parts.

Carbon-based electrodes suitable for incorporation into energy storage devices are known. Activated carbon is widely used as a porous material in ultracapacitors due to its large surface area, electronic conductivity, ionic capacitance, chemical stability, and/or low cost. Activated carbon can be made from synthetic precursor materials such as phenolic resins, or natural precursor materials such as coals or biomass. With both synthetic and natural precursors, the activated carbon can be formed by first carbonizing the precursor and then activating the intermediate product. The activation can comprise physical (e.g., steam) or chemical activation at elevated temperatures to increase the porosity and hence the surface area of the carbon. The carbon-based electrodes can include, in addition to activated carbon, a conductive carbon such as carbon black, and a binder such as polytetrafluoroethylene (PTFE) or polyvinylidene fluoride (PVDF). The activated carbon-containing layer (carbon mat) is typically laminated over a current collector to form the carbon-based electrode.

The choice of separator and electrode materials directly affect the performance of the device, including the achievable energy density and power density. The energy density (E) of an EDLC is given by E=¹/2 CV², where C is the capacitance and V is the device's operating voltage. Recently, engineered carbon materials have been developed to achieve higher capacitance. To achieve higher capacitance, activated carbon materials with high surface area (500-2500 m²/g) may be used.

A further approach to increasing the energy density is to increase the capacitor's operating voltage. In this regard, aqueous electrolytes have been used in EDLCs for lower voltage (<1V) operation, while organic electrolytes have been used for higher voltage (2.3-2.7 V) devices. However, to achieve even higher energy densities, there is a need to increase the voltage envelop from conventional values of about 2.7 V to around 3.0 V. Such an increase from 2.7 to 3.0 V will result in a 23% increase in the energy density.

A method of making a carbon-based electrode includes forming a mixture comprising activated carbon, carbon black, binder, and an optional liquid. In embodiments, at least the binder is maintained at a temperature less than 19° C. during the mixing. In further embodiments, the entire mixture of activated carbon, carbon black, binder, and optional liquid is maintained at a temperature less than 19° C. during the mixing. In still further embodiments, a dry mixture of activated carbon, carbon black, binder can be maintained at a temperature less than 19° C. during the mixing. A carbon mat can be formed from the mixture, and the carbon mat can be laminated onto a current collector to form a carbon-based electrode.

The mixture can include, as a percentage of solids, 5-20 wt. % binder, 1-5 wt. % carbon black, balance activated carbon. An example mixture includes 10 wt. % binder, 5 wt. % carbon black and 85 wt. % activated carbon.

By maintaining the temperature of the binder below a phase transition temperature of the binder material, it is possible to improve the dispersion and distribution of the binder particles as well as the carbon particles in the mixture. In example methods, a mixing temperature is maintained below 19° C., e.g., at about 10° C. or 5° C., or below 5° C.

The binder in various embodiments is polytetrafluoroethylene. Polytetrafluoroethylene (FIFE) is a synthetic fluoropolymer of tetrafluoroethylene. The composition of PTFE can be represented by the molecular formula (C₂F₄)ₙ. PTFE is commercially-available as a white powder composed of agglomerated particles. The agglomerated particles are formed from a plurality of primary (non-agglomerated) particles. The primary particle size (of individual particles) can range from about 0.05 to 0.5 microns, while the agglomerated PTFE may have a secondary (e.g., agglomerated) particle size of −5 mm.

The mixture can include 1-20 wt. % of a carrier/solvent liquid such as isopropyl alcohol (IPA), n-methyl pyrrolidone (NMP), or tetrahydrofuran (THF), which can facilitate adhesion of the component particles during processing as well as the formation of a carbon mat of the components via calendaring. The liquid solvent can also induce swelling of the binder and minimized the formation of dust. The liquid carrier/solvent can be free of water.

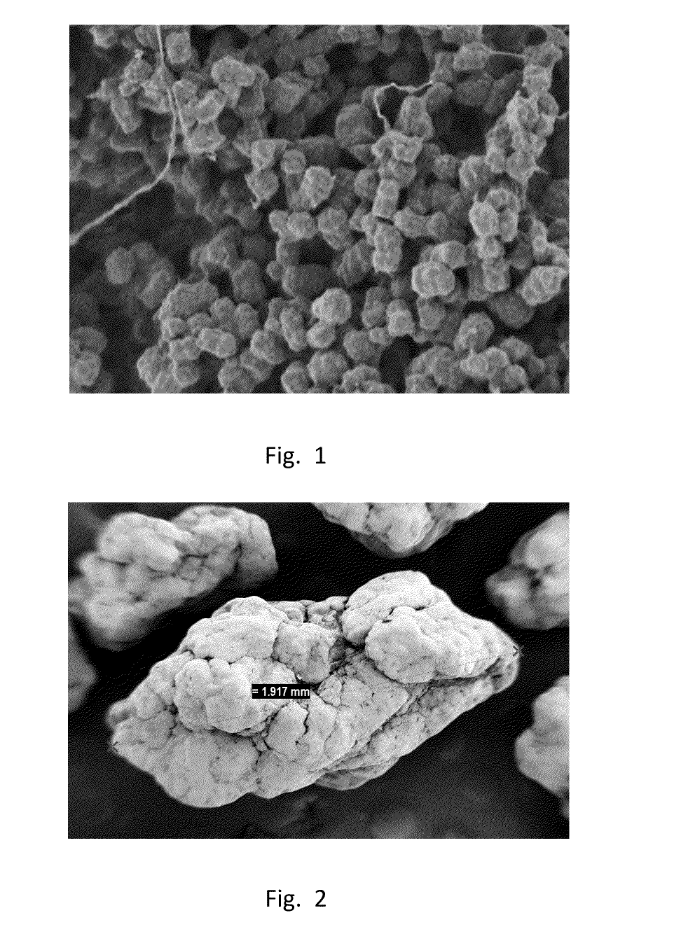

A scanning electron microscope (SEM) micrograph of individual (primary) PTFE particles is shown in FIG. 1. The primary particle size is about 200 nm. An SEM micrograph of agglomerated (secondary) PTFE particles is shown in FIG. 2. The agglomerate particle size is about 2 mm.

Through low temperature mixing, the present approach involves the de-agglomeration of PTFE particles from a supplied size of about 2 mm, which results in more effective PTFE fibrillation and network formation and the attendant formation of a high strength, high performance carbon-based electrode. Such low-temperature processing yields dispersive and distributive mixing of the components. Dispersive mixing breaks up the PTFE agglomerates into smaller sizes, and distributive mixing homogenizes the distribution of the binder, activated carbon and carbon black with respect to each other.

PTFE has a density of about 2.2 g/cm³ and a melting point of about 327° C. At atmospheric pressure, crystalline or partially-crystalline polytetrafluoroethylene undergoes several phase changes from sub-ambient temperatures up to the melting point. Below about 19° C., PTFE comprises a well-ordered, hexagonal crystal structure (phase II). At higher temperatures, the crystalline PTFE turns into a partially-ordered hexagonal phase (phase IV—between 19 and 30° C.), while above 30° C. the material converts into a pseudohexagonal, disordered phase (phase I). This phase is stable until the material reaches the melting region around 327° C.

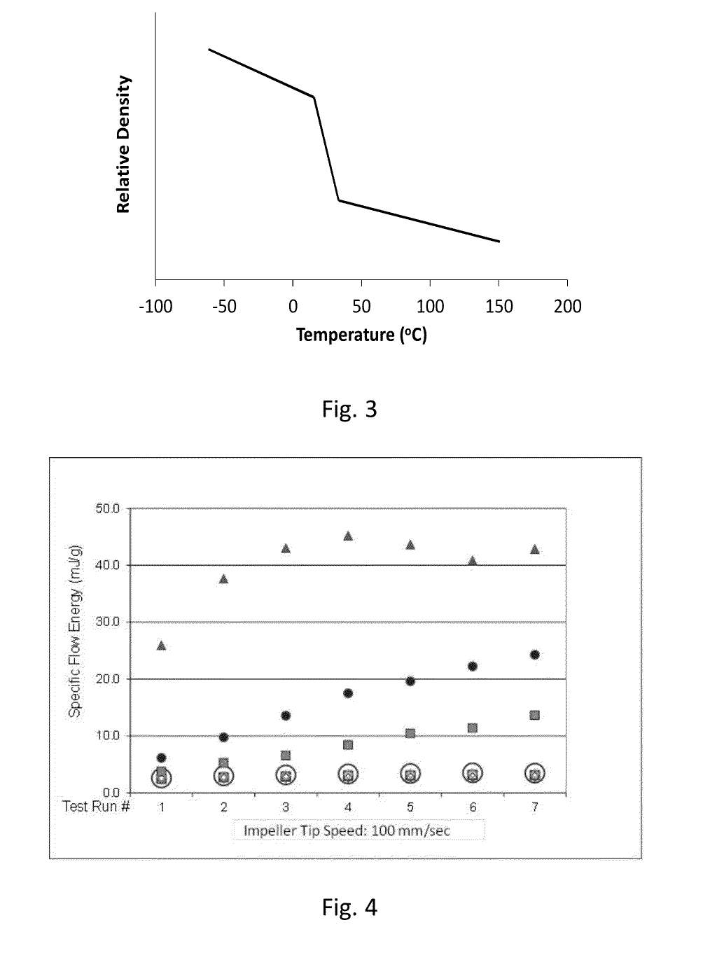

PTFE comprises a fully-fluorinated carbon-carbon backbone chain. Along the chain, fluorine atoms are arranged in spiral. The spiral packing is dense. It takes about 26 carbon atoms for a full turn of the spiral below 19° C. and 30 carbon atoms for a full turn above 19° C. A plot of the relative density of PTFE versus temperature is shown in FIG. 3. which illustrates the phase transformation of hexagonal PTFE from phase II to phase TV at about 19° C. At temperatures less than 19° C., PTFE is brittle. Thus, mixing at a reduced binder temperature of less than 19° C. will facilitate fragmentation of the PTFE agglomerates and blend the PTFE particles with the activated carbon and carbon black. In embodiments, fibrillation of the binder is avoided during the mixing. In various methods, the temperature of the individual components (activated carbon, carbon black and binder) can be controlled as they are mixed.

By avoiding fibrillation during the mixing, the powder is free-flowing and can be easily fed into a mill or extruder for fibrillation. Flow characteristics of the powder mixture can be quantified using powder rheology test methods.

A FT4 powder rheometer was used to determine flow energy (FE) and powder flow viscosity. Flow energy testing involves a series of alternating conditioning and test cycles (reference) designed to assess if the powder will change as a result of being made to flow. Any large change in the flow energy during the test is a result of the powder flow properties changing. The magnitude of the change relates to the powder's stability while the direction of the change (increase or decrease in energy) can be an indicator of one or more causes related to the instability.

Flow energy is typically mass normalized and plotted as the specific flow energy (SFE) as a function of the flow rate (e.g., at 10, 40, 70, 100 mm/s). Multiple runs are conducted at 100 mm/s to evaluate the stability of the powder and then test runs are conducted at 100, 70, 40 and 10 mm/s sequentially.

Specific flow energy (SFE) is plotted as a function of flow rate in FIG. 4. The open squares are a control sample (carbon type A, as defined below, using a ProcessAll mixer). The open circles represent the target of essentially no change in specific flow energy with increasing flow rate.

Runs 1-5 were performed using a Henschel mixer (HM). HM runs 1 and 4 (overlapping open diamonds) fall within the target and ProcessAll control, evidencing stable flow consistent with no fibrillation of the PTFE. However, HM Runs 2, 3 and 5 (filled triangles, filled squares and filled circles) show varying degrees of flow instability indicating a mild to substantial fibrillation took place in the HM.

The greater the flow energy over time, the greater the degree of fibrillation and the greater the resistance to flow. The linear behavior for HM runs 3 and 5 indicates a steady increase in agglomeration over time, suggesting a mild to aggressive fibrillation occurring in the HM. HM run 2 indicates a very aggressive fibrillation occurred in the HM, particularly in light of the higher starting SFE and the odd flow behavior. The results are summarized in Table 1.

TABLE 1
Summary of flow energy tests

| | | | | Instability Index |
|---|---|---|---|---|
| Run | Symbol | Mixer | Conditions | (mJ/g · run) |
| Target | ∘ | | | 10 |
| Control | □ | ProcessAll | 45 min mix; 5° C.; | 8 |
| | | | 2900 rpm | |
| 1 | ⋄ | Henschel | 20 min mix; 15° C.; | 5 |
| | | | 2000 rpm | |
| 2 | ▴ | Henschel | 40 min mix; 15° C.; | 235 |
| | | | 4000 rpm | |
| 3 | ▪ | Henschel | 30 min mix; 10° C.; | 40 |
| | | | 3000 rpm | |
| 4 | ⋄ | Henschel | 40 min mix; 5° C.; | 10 |
| | | | 2000 rpm | |
| 5 | • | Henschel | 20 min mix; 5° C.; | 88 |
| | | | 4000 rpm | |

A flow energy instability index (mJ/g.run) can be calculated from the FIG. 4 data, corresponding to the area under the curve for the SFE data. In summary, HM runs 1 and 4 approximated the ProcessAll control indicating the HM is capable of producing batches similar to or the same as the ProcessAll process. The HM is also capable of fibrillating the batch to varying degrees, as indicated by HM runs 2, 3 and 5.

The mixture (dry or wet) can be fibrillated, for example, in a jet mill or screw extruder such as a single screw or double screw extruder. A 4 inch micronizer jet mill with a tungsten carbide lining was used for the fibrillation process in conjunction with several examples disclosed herein. The mixture, prior to loading into the jet mill, can be sieved through a 10 mesh screen to remove the larger sized particles. A grind pressure of 50-200 psi (e.g., 80-120 psi), feed pressure of 40-100 psi (e.g., 60-80 psi) and a feed rate of about 0.5-2 kg/hr (e.g., 0.8-1.5 kg/hr) were used for the jet mill fibrillation process in various examples. In addition to or in lieu of reducing the particle size prior to fibrillating (milling), a step of reducing the particle size can be performed after milling but before calendaring. The mixture temperature during jet milling (or extruding) can be at least 25° C., e.g., at least 30° C.

In various methods, a temperature of the individual components (activated carbon, carbon black and binder) can be controlled as the components are fed into, mixed and fibrillated within a fibrillation apparatus.

The shear stresses created by the jet mill form fibrils of the binder material. PTFE, for example, is fibrillated to form a network structure (of fibrils). Activated carbon particles, and carbon black particles are taken up into the network structure without being coated with the binder. The fibrils formed in the fibrillation bind the activated carbon and carbon black particles in the carbon mat.

PTFE particles can be fibrillated to about 100 times their diameter without fracture. Fibrillating large agglomerated particles of PTFE, however, decreases the intricacy of the PTFE network by producing large, thick fibers of PTFE. Fibrillating smaller (e.g., primary) particles of PTFE promotes the formation of a mechanically-robust carbon mat.

Wet fibrillation can be conducted in equipment that applies considerable shear to the activated carbon, carbon black and PTFE mixture. Example fibrillation apparatus include screw extruders (i.e., augers) including a twin screw extruder. In one embodiment, a fibrillation method applies shear via gas pressure, i.e., without the use of grinding media. Such an approach may use a jet mill or fluidized bed jet mill wherein PTFE fibrillation is caused by high-velocity collisions between particles in the mixture. The use of a liquid helps to minimize dust during handling.

The fibrillated mixture can be calendared and laminated onto a current collector. With calendaring, the fibrillated electrode mixture is passed through a series of rollers to form a densified sheet (carbon mat). The temperature of the rollers may range from about 25-150° C., e.g., about 100° C. The application of pressure during lamination may be performed at elevated temperature, e.g., about 200° C.

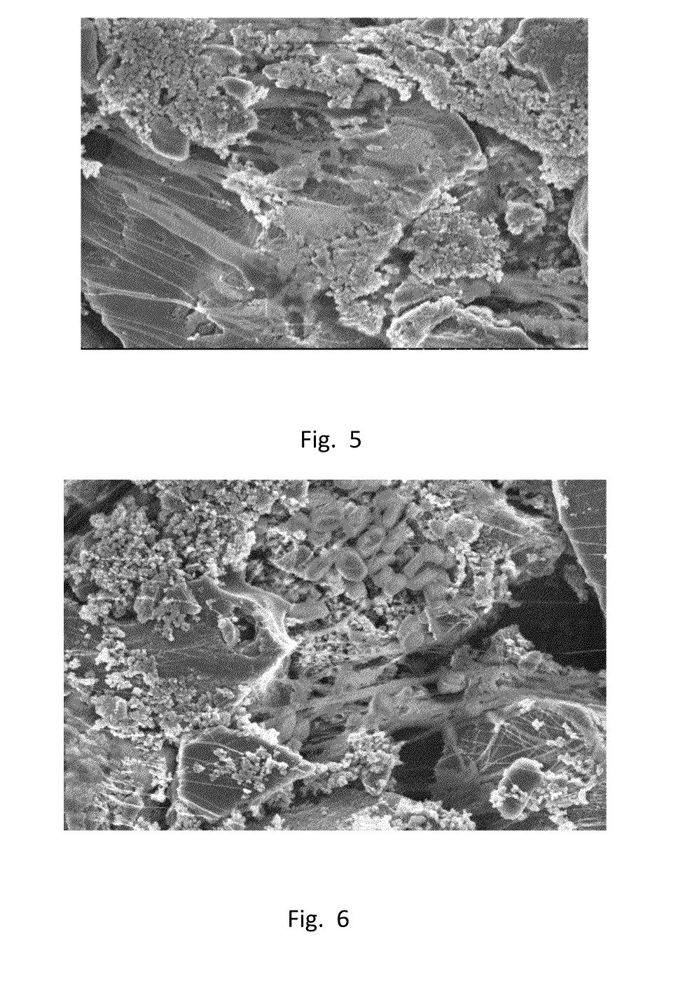

An SEM image of a carbon mat comprising de-agglomerated and fibrillated PTFE, activated carbon and carbon black is shown in FIG. 5. A further SEM image of a carbon mat comprising de-agglomerated and fibrillated PTFE, activated carbon and carbon black is shown in FIG. 6. The carbon mat in FIG. 5 includes steam-activated carbon derived from coconut shells (Type A carbon). The carbon mat in FIG. 6 includes KOH-activated carbon derived from wheat flour (Type B carbon).

In embodiments, a free-standing carbon mat is laminated onto one or both sides of a conductive current collector. The current collector can be, for example, a 15-25 μm (e.g., 20 micron) thick aluminum foil that is optionally pre-coated with a layer of conductive carbon such as carbon ink (e.g., DAG EB012 conductive coating from Henkel (formerly Acheson) or thermally-grown carbon. With respect to commercially-available conductive inks, which may contain about 5 wt. % binder, thermally grown carbon may contain fewer transition metal contaminants, which can aid in minimizing unwanted Faradic reactions.

By way of example, the successive steps of mixing, fibrillation, calendaring and lamination can be used to form a carbon-based electrode.

A pair of carbon-based electrodes can be wound together with inter-disposed separators and packaged together with a suitable electrolyte to form an EDLC. For example, the laminated electrodes are cut to the appropriate dimensions and wound into a jelly roll together with cellulosic separator paper (NKK TF4030). The current collector ends are smeared and laser welded to terminals. The assembly is then packaged into an aluminum can and sealed. The resulting cell is dried in vacuum at 130° C. for 48 hrs. Electrolyte is filled into the cell, and the cell is sealed.

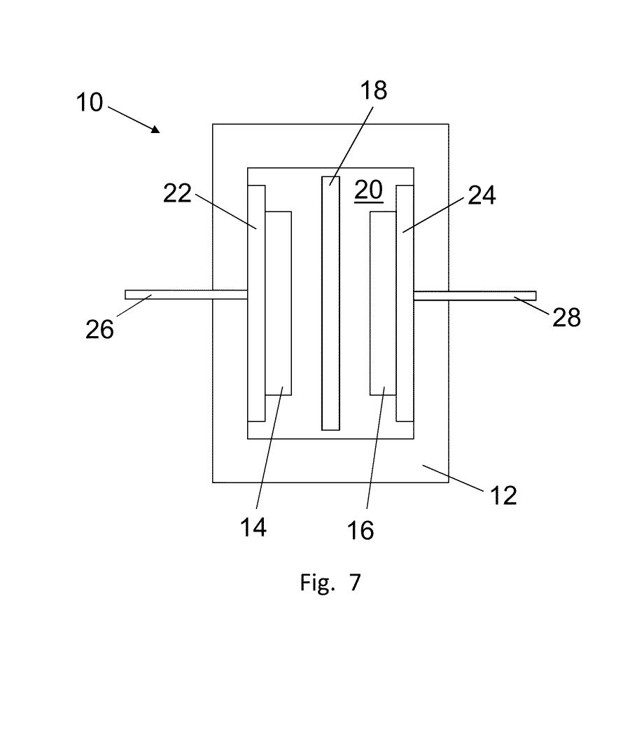

FIG. 7 is a schematic illustration of an example ultracapacitor. Ultracapacitor 10 includes an enclosing body 12, a pair of current collectors 22, 24, a first carbon mat 14 and a second carbon mat 16 each respectively formed over one of the current collectors, and a porous separator layer 18. Electrical leads 26, 28 can be connected to respective current collectors 22, 24 to provide electrical contact to an external device. Layers 14, 16 may comprise activated carbon, carbon black and a binder. A liquid electrolyte 20 is contained within the enclosing body and incorporated throughout the porosity of both the porous separator layer and each of the porous electrodes. In embodiments, individual ultracapacitor cells can be stacked (e.g., in series) to increase the overall operating voltage.

The enclosing body 12 can be any known enclosure means commonly-used with ultracapacitors. The current collectors 22, 24 generally comprise an electrically-conductive material such as a metal, and commonly are made of aluminum due to its electrical conductivity and relative cost. For example, current collectors 22, 24 may be thin sheets of aluminum foil.

Porous separator 18 electronically insulates the electrodes from each other while allowing ion diffusion. The porous separator can be made of a dielectric material such as cellulosic materials, glass, and inorganic or organic polymers such as polypropylene, polyesters or polyolefins. In embodiments, a thickness of the separator layer can range from about 10 to 250 microns.

The electrolyte 20 serves as a promoter of ion conductivity, as a source of ions, and may serve as a binder for the carbon. The electrolyte typically comprises a salt dissolved in a suitable solvent. Suitable electrolyte salts include quaternary ammonium salts such as those disclosed in commonly-owned U.S. patent application Ser. No. 13/682,211, the disclosure of which is incorporated herein by reference. Example quaternary ammonium salts include tetraethylammonium tetraflouroborate ((Et)₄NBF₄) or triethylmethyl ammonium tetraflouroborate (Me(Et)₃NBF₄).

Ultracapacitors may have a jelly roll design, prismatic design, honeycomb design, or other suitable configuration. A carbon-based electrode made according to the present disclosure can be incorporated into a carbon-carbon ultracapacitor or into a hybrid ultracapacitor. In a carbon-carbon ultracapacitor, both of the electrodes are carbon-based electrodes. In a hybrid ultracapacitor, one of the electrodes is carbon-based, and the other electrode can be a pseudo capacitive material such as lead oxide, ruthenium oxide, nickel hydroxide, or another material such as a conductive polymer (e.g., parafluorophenyl-thiophene).

In carbon-carbon ultracapacitors, the activated carbon in each electrode may have the same, similar or distinct properties. For example, the pore size distribution of the activated carbon incorporated into a positive electrode may be different than the pore size distribution of the activated carbon incorporated into a negative electrode.

The activated carbon used in conjunction with the carbon-based electrodes disclosed herein can have a specific surface area greater than about 300 m²/g, i.e., greater than 350, 400, 500 or 1000 m²/g. The specific surface area of the activated carbon can range from 1000-2500 m²/g. In embodiments, the average particle size of the activated carbon can be milled to less than 20 microns, e.g., about 5 microns, prior to incorporating the activated carbon into a carbon-based electrode.

Within an individual ultracapacitor cell, and under the influence of an applied electric potential, an ionic current flows due to the attraction of anions in the electrolyte to the positive electrode and cations to the negative electrode. Ionic charge can accumulate at each of the electrode surfaces to create charge layers at the solid-liquid interfaces. The accumulated charge is held at the respective interfaces by opposite charges in the solid electrode to generate an electrode potential.

During discharge of the cell, a potential across the electrodes causes ionic current to flow as anions are discharged from the surface of the positive electrode and cations are discharged from the surface of the negative electrode. Simultaneously, an electronic current can flow through an external circuit located between the current collectors. The external circuit can be used to power electrical devices.

Ultracapacitors comprising the carbon-based electrodes made by the process disclosed herein may, in some embodiments, exhibit operating voltages up to 3.2 V (e.g., 2.7, 2.8, 2.9, 3.0, 3.1 or 3.2V) and a volumetric capacitance of greater than 50 F/cm³ (e.g., greater than 50, 60, 70, or 80 F/cm³), including capacitance values between any of the foregoing values.

### EXAMPLES

### Example 1

### Fibrillation of Agglomerated PTFE

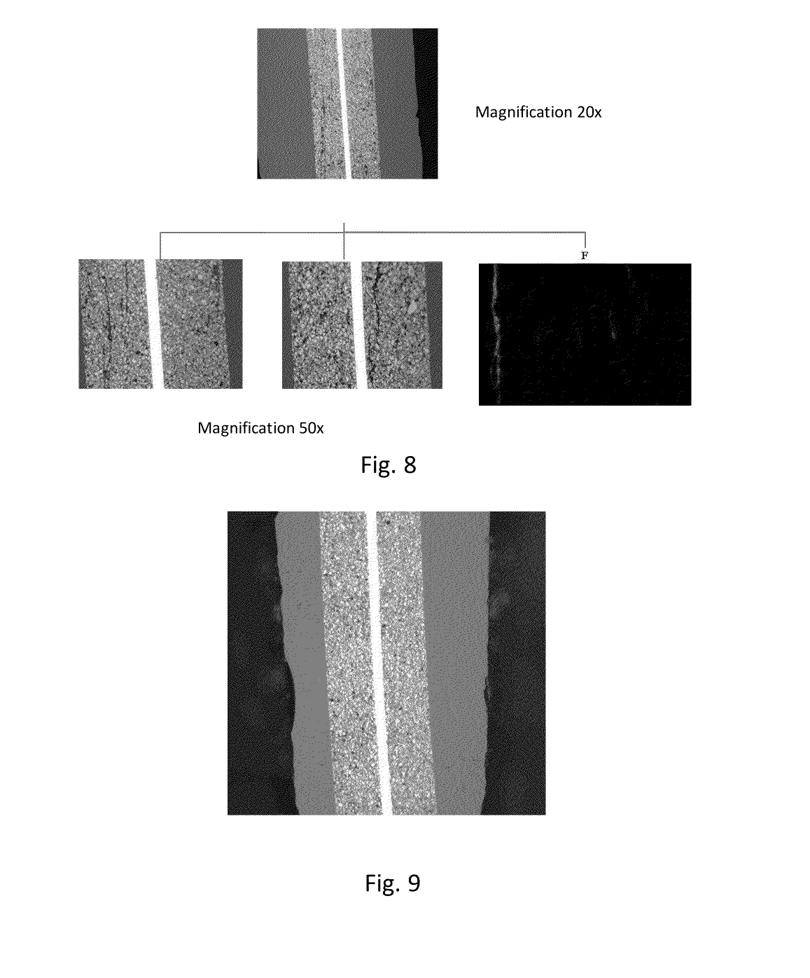

Following a mixing step at about 25° C., PTFE fibrillation without initial de-agglomeration leads to large PTFE fibers that can adversely affect uniformity and strength of the carbon mat and the resulting carbon-based electrode. FIG. 8 shows optical micrographs at 20× and 50× of carbon-based electrodes according to a comparative method. An energy-dispersive x-ray map shows high concentrations of fluorine that correspond to large PTFE fibers within the carbon mat.

### Example 2

### Fibrillation of Non-Agglomerated PTFE

Following a mixing step at less than 19° C. (e.g., 5° C. or 10° C.) PTFE fibrillation after de-agglomeration leads to fine PTFE fibrils that are uniformly dispersed throughout the carbon mat. FIG. 9 shows an optical micrograph of a carbon-based electrode according to an embodiment.

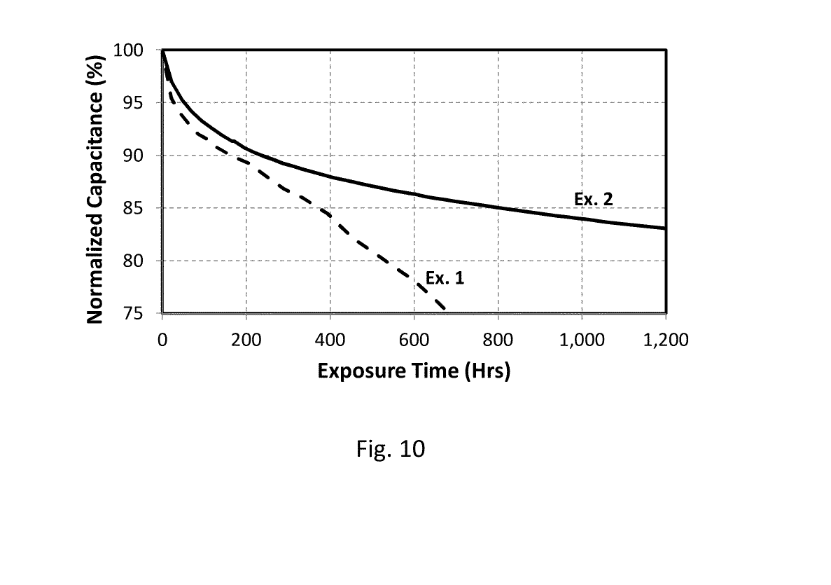

As shown in FIG. 10, capacitance decay of a test cell comprising the Example 2 electrodes was significantly slower than that of an Example 1 test cell. The improved cell stability from 2.5 to 2.7V in a stress test at 65° C. is attributable to the improved strength and stability of the Example 2 electrodes compared with the Example 1 comparative electrodes.

Referring still to FIG. 10, the normalized capacitance for the Example 1 electrode degrades to 80% of its initial value at about 500 hr, while the normalized capacitance for the Example 2 electrode exceeds 80% of its initial value at 1200 hr. In embodiments, an EDLC comprising a carbon-based electrode has a normalized capacitance of at least 80% of an initial capacitance at 1200 hr.

The carbon mat made with the disclosed approach can have a tensile strength in the longitudinal (rolling) direction of 0.2 to 2 MPa (e.g., at least 0.7 MPa), and a tensile strength in the transverse direction (perpendicular to the rolling direction) of 0.1 to 1 MPa (e.g., at least 0.35 MPa).

### Example 3

### Ball Milling—Carbon Type A

Electrodes were fabricated utilizing a ball milling route. The carbon mat constituents including 85 wt. % activated carbon (Type A), 5 wt. % carbon black (Cabot BP2000) and 10 wt. % PTFE (DuPont 601A) were mixed for 1 hour in Turbula mixer containing 10 agate media balls (25 mm diameter) at room temperature. The mixture was transferred into a US stoneware metal jar with urethane liner. The mixer was purged with argon gas and the contents roll milled. Forty-two 40 mm diameter agate media balls were utilized for grinding. The milling was carried out for 1 hour at 60 rpm after which 80 wt. % IPA was added. The addition of the IPA was followed by an additional 1 hour of roll milling.

The resulting material was cooled and transferred to a vacuum oven. The mixture was vacuum dried for 9 hours at 150° C. The material from the vacuum oven was de-agglomerated in Fitz mill, which was run at 3600 rpm and 1 g/sec feed rate using a 0.020″ screen size. The de-agglomerated powder was then calendared to make a 100 μm thick free-standing carbon web. The tensile strength of the free-standing carbon mat is presented in Table 2. The tensile strength in the longitudinal and transverse directions was 0.12 MPa and 0.06 MPa, respectively.

In Table 2, carbon Type A is a steam activated carbon with a D50 particle size of about 5 microns. Carbon Type B is an alkali activated carbon with a D50 particle size of about 5 microns. Fitz Mill-s1 refers to a Fitz mill with a 0.020″ mesh screen, and Fitz Mill-s2 refers to a Fitz mill with a 0.065″ mesh screen. Carbon mat tensile strength is reported in MPa in both the longitudinal (L) and transverse (T) directions.

TABLE 2
Electrode example with different manufacturing process conditions

| | | | De- | | Tensile | Tensile |
|---|---|---|---|---|---|---|
| Ex. # | Mixing | Fibrillation | agglomeration | Carbon | Strength - L | Strength - T |
| 3 | Ball Mill | Ball Mill | None | A | 0.12 | 0.06 |
| 4 | Lab Master | Twin Screw | Fitz Mill-s1 | A | 0.23 | 0.12 |
| 5 | Lab Master | Twin Screw | Fitz Mill-s1 | B | 0.19 | 0.10 |
| 6 | ProcessAll | Twin Screw | Fitz Mill-s1 | A | 0.56 | 0.25 |
| 7 | ProcessAll | Twin Screw | Fitz Mill-s1 | B | 0.37 | 0.16 |
| 8 | ProcessAll | Jet Mill | Fitz Mill-s2 | A | 0.78 | 0.40 |
| 9 | ProcessAll | Jet Mill | Fitz Mill-s2 | A | 0.83 | 0.41 |
| 10 | ProcessAll | Jet Mill | Fitz Mill-s2 | A | 0.82 | 0.42 |
| 11 | ProcessAll | Jet Mill | Fitz Mill-s2 | A | 0.88 | 0.45 |
| 12 | ProcessAll | Jet Mill | Fitz Mill-s2 | A | 0.75 | 0.41 |
| 13 | ProcessAll | Jet Mill | Fitz Mill-s2 | A | 0.89 | 0.46 |
| 14 | Henschel | Jet Mill | Fitz Mill-s2 | A | 0.95 | 0.48 |
| 15 | Henschel | Jet Mill | Fitz Mill-s2 | A | 0.90 | 0.46 |
| 16 | Henschel | Jet Mill | Fitz Mill-s2 | B | 0.62 | 0.32 |
| 17 | Henschel | Jet Mill | Fitz Mill-s1 | A | 0.73 | 0.37 |

### Example 4

### LabMaster+TwinScrew—Carbon Type A

Carbon-based electrodes were fabricated utilizing LabMaster mixing at room temperature and twin screw fibrillation at 30° C. The carbon mat constituents containing 85 wt. % activated carbon (Type A), 5 wt. % carbon black (Cabot BP2000) and 10 wt. % PTFE (DuPont 601A) were mixed for 8 minutes in a LabMaster mixer at a tumble speed of 20 rpm, and impeller speed of 3000 rpm. The mixture was fibrillated utilizing a twin screw machine at a feed rate of 0.45 kg/hour at 30° C. The resulting granules were broken utilizing a Fitz Mill, which was run at 3600 rpm and 1 g/sec feed rate with a 0.020″ screen size. The de-agglomerated powder was then calendared to make a 100 μm thick free-standing carbon web. As summarized in Table 2, the tensile strength of the carbon mat in the longitudinal and transverse directions was 0.23 MPa and 0.12 MPa, respectively.

### Example 5

### LabMaster+TwinScrew—Carbon Type B

Carbon-based electrodes were fabricated as detailed in Example 4, but utilizing carbon Type B. The tensile strength of the carbon mat in the longitudinal and transverse directions was 0.19 MPa and 0.10 MPa, respectively.

### Example 6

### ProcessAll+TwinScrew—Carbon Type A

Electrodes were fabricated utilizing ProcessAll mixing (5° C.) and twin screw fibrillation (50° C.). The electrode constituents containing 85 wt. % activated carbon (Type A), 5 wt. % carbon black (Cabot BP2000) and 10 wt. % PTFE (DuPont 601A) were mixed in a temperature-controlled ProcessAll mixer. The main shaft was set to 100 rpm and the chopper shaft was set to 2900 rpm. The chiller temperature was set to 5° C.

After 40 min of dry mixing, 5 wt. % IPA was injected into the mixer. The wet mixing was performed for 5 min, resulting in total mixing time of 45 minutes. The mixture was fibrillated utilizing a twin screw machine at a feed rate of 0.45 kg/hour at 50° C. The resultant granules were broken utilizing a Fitz Mill, which was run at 3600 rpm and a 1 g/sec feed rate with a 0.020″ screen size. The de-agglomerated powder was then calendared to make a 100 μm thick free-standing carbon web. Table 2 provides the tensile strength of the free-standing sheet. The tensile strength of the carbon mat in the longitudinal and transverse direction tensile strength was 0.56 MPa and 0.25 MPa, respectively.

### Example 7

### ProcessAll+TwinScrew (Carbon B)

Electrodes were fabricated as detailed in Example 6, but utilizing carbon Type B. The tensile strength in the longitudinal and transverse direction was 0.37 MPa and 0.16 MPa, respectively.

### Example 8

### ProcessAll+Jet Mill (Carbon A)

Electrodes were fabricated utilizing ProcessAll mixing (5° C.) and jet mill fibrillation. The electrode constituents containing 85 wt. % activated carbon Type A, 5 wt. % carbon black (Cabot BP2000) and 10% PTFE (DuPont 601A) were mixed as detailed in Example 6. The mixture was fibrillated utilizing a jet mill.

The process parameters for the jet mill were: feed pressure 70 psi; feed rate 1500 g/hr; and grind pressure 65 psi. The resultant mixture was de-agglomerated utilizing a Fitz Mill which was run at 3600 rpm and a 1 g/sec feed rate and using a 0.065″ screen size. The de-agglomerated powder was then calendared to make a 100 μm thick free-standing carbon web. The tensile strength of the carbon mat in the longitudinal and transverse directions was 0.78 MPa and 0.40 MPa, respectively.

### Example 9

### ProcessAll+Jet Mill (Carbon A)

Electrodes were fabricated as detailed in Example 8, but with jet mill process parameters as follows: feed pressure 70 psi; feed rate 2000 g/hr; and grind pressure 85 psi. The tensile strength of the resulting carbon mat in the longitudinal and transverse directions was 0.83 MPa and 0.41 MPa, respectively.

### Example 10

### ProcessAll+Jet Mill (Carbon A)

Electrodes were fabricated as detailed in Example 8, but with jet mill process parameters as follows: feed pressure 70 psi; feed rate 2000 g/hr; and grind pressure 45 psi. The carbon mat tensile strength in the longitudinal and transverse directions was 0.82 MPa and 0.42 MPa, respectively.

### Example 11

### ProcessAll+Jet Mill (Carbon A)

Electrodes were fabricated as detailed in Example 8, but with jet mill process parameters as follows: feed pressure 70 psi; feed rate 1000 g/hr; and grind pressure 45 psi. The carbon mat tensile strength in the longitudinal and transverse directions was 0.88 MPa and 0.45 MPa, respectively.

### Example 12

### ProcessAll+Jet Mill (Carbon A)

Electrodes were fabricated as detailed in Example 8, but with jet mill process parameters as follows: feed pressure 70 psi; feed rate 1000 g/hr; and grind pressure 85 psi. The tensile strength of the resulting carbon mat in the longitudinal and transverse directions was 0.75 MPa and 0.41 MPa, respectively.

### Example 13

### ProcessAll+Jet Mill (Carbon A)

Electrodes were fabricated as detailed in Example 8, but with jet mill process parameters as follows: feed pressure 70 psi; feed rate 1500 g/hr; and grind pressure 65 psi. The tensile strength of the resulting carbon mat in the longitudinal and transverse directions was 0.89 MPa and 0.46 MPa, respectively.

### Example 14

### Henschel+Jet Mill (Carbon A)

Electrodes were fabricated utilizing Henschel FML 10 high intensity shear mixing (5° C.) and jet mill fibrillation. The electrode constituents containing 85 wt. % activated carbon Type A, 5 wt. % carbon black (Cabot BP2000) and 10% PTFE (DuPont 601A) were mixed in a temperature-controlled Henschel mixer. The impeller speed was set to 2000 rpm. The chiller temperature was set to 5° C. After 40 min of dry mixing, 5 wt. % IPA was sprayed into the mixer. The wet mixing was performed for 5 min, resulting in total mixing time of 45 minutes. The mixture was fibrillated utilizing a jet mill. The process parameters for the Jet Mill were: feed pressure 70 psi, feed rate 1000 g/hr, and grind pressure 85 psi.

The resultant mixture was de-agglomerated utilizing a Fitz Mill, which was run at 3600 rpm and 1 g/sec feed rate and using a 0.065″ screen size. The de-agglomerated powder was then calendared to make a 100 μm thick free-standing carbon web. The tensile strength of the carbon mat in the longitudinal and transverse directions was 0.95 MPa and 0.48 MPa, respectively.

### Example 15

### Henschel+Jet Mill (Carbon A)

Electrodes were fabricated as detailed in Example 14, but with a mixing time of 20 minutes (which includes 15 min dry mixing and 5 min wet mixing after adding 5 wt. % IPA). The tensile strength in the longitudinal and transverse directions was 0.90 MPa and 0.46 MPa, respectively.

### Example 16

### Henschel+Jet Mill (Carbon B)

Electrodes were fabricated as detailed in Example 14, but utilizing carbon Type B. The tensile strength in the longitudinal and transverse directions was 0.62 MPa and 0.32 MPa, respectively.

### Example 17

### Henschel+Jet Mill (Carbon A)

Electrodes were fabricated as detailed in Example 14, but utilizing a 0.020″ screen size in the Fitz Mill. The tensile strength in the longitudinal and transverse directions was 0.73 MPa and 0.37 MPa, respectively.

As used herein, the singular forms “a,” “an” and “the” include plural referents unless the context clearly dictates otherwise. Thus, for example, reference to a “binder” includes examples having two or more such “binders” unless the context clearly indicates otherwise.

Ranges can be expressed herein as from “about” one particular value, and/or to “about” another particular value. When such a range is expressed, examples include from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It is also noted that recitations herein refer to a component being “configured” or “adapted to” function in a particular way. In this respect, such a component is “configured” or “adapted to” embody a particular property, or function in a particular manner, where such recitations are structural recitations as opposed to recitations of intended use. More specifically, the references herein to the manner in which a component is “configured” or “adapted to” denotes an existing physical condition of the component and, as such, is to be taken as a definite recitation of the structural characteristics of the component.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to a carbon-based electrode that comprises activated carbon, carbon black and binder include embodiments where the carbon-based electrode consists of activated carbon, carbon black and binder and embodiments where a carbon-based electrode consists essentially of activated carbon, carbon black and binder.

It will be apparent to those skilled in the art that various modifications and variations can be made to the present invention without departing from the spirit and scope of the invention. Since modifications, combinations, sub-combinations and variations of the disclosed embodiments incorporating the spirit and substance of the invention may occur to persons skilled in the art, the invention should be construed to include everything within the scope of the appended claims and their equivalents.

We claim:

1. A method of forming a carbon-based electrode, comprising:
forming a mixture including activated carbon particles, carbon black particles, binder, and an optional liquid;
fibrillating the binder to form a fibrillated mixture; and
forming a carbon mat from the fibrillated mixture, wherein the binder temperature is less than 19° C. during the act of forming the mixture.

2. The method according to claim 1, wherein during the act of forming the mixture the activated carbon temperature, the carbon black temperature, the binder temperature, and the optional liquid temperature are each less than 19° C.

3. The method according to claim 1, wherein the binder is polytetrafluoroethylene.

4. The method according to claim 1, wherein the mixture prior to fibrillating comprises un-agglomerated, primary particles of the binder.

5. The method according to claim 1, wherein the mixture prior to fibrillating consists essentially of activated carbon particles, carbon black particles, primary particles of the binder and the optional liquid.

6. The method according to claim 1, wherein the mixture prior to fibrillating is free of fibrils.

7. The method according to claim 1, wherein the mixture includes 1 to 20 wt. % of the liquid.

8. The method according to claim 1, wherein the fibrillating comprises jet milling the mixture.

9. The method according to claim 1, wherein the fibrillating comprises jet milling the mixture at a mixture temperature of at least 25° C.

10. The method according to claim 1, wherein the fibrillating comprises jet milling the mixture without a solid grinding media.

11. The method according to claim 1, wherein the fibrillating comprises extruding the mixture.

12. The method according to claim 1, wherein the fibrillated mixture is calendared to form the carbon mat.

13. The method according to claim 1, further comprising laminating the carbon mat onto a current collector to form a carbon-based electrode.

14. The method according to claim 13, wherein the current collector comprises an aluminum sheet having a first conductive layer disposed adjacent to a first major surface of the sheet and a second conductive layer disposed adjacent to a second major surface of the sheet, and
a first carbon mat is laminated over the first conductive layer and a second carbon mat is laminated over the second conductive layer.

15. The method according to claim 14, wherein the first and second conductive layers comprise conductive carbon.

16. The method according to claim 1, comprising forming the mixture including activated carbon particles, carbon black particles and binder where a temperature of the binder is less than 19° C. during the act of forming the mixture and then adding a liquid to the mixture.

17. An EDLC comprising a carbon-based electrode according to claim 1, wherein the EDLC has a normalized capacitance of at least 80% of an initial capacitance at 1200 hr.
